(19) United States
(12) Patent Application Publication
(10) Pub. No.: US 2023/0193089 A1
(43) Pub. Date: Jun. 22, 2023

(54) MULTI-USE ADHESIVE TAPE

(71) Applicant: Lewis Boxes Pty Ltd, East Brisbane, Queensland (AU)

(72) Inventor: Gavin John Lewis, East Brisbane (AU)

(21) Appl. No.: 17/925,560

(22) PCT Filed: May 12, 2021
(86) PCT No.: PCT/AU2021/050444

§ 371 Date: Nov. 15, 2022

(30) Foreign Application Priority Data
May 15, 2020 (AU) 2020901569

(51) Int. Cl. C09J 7/40

(52) U.S. Cl. CPC C09J 7/403; C09J 2483/005; C09J 2467/005; C09J 2471/005; C09J 2423/005; C09J 2301/208; C09J 2301/302

(57) ABSTRACT

A multi-use adhesive tape including a first backing layer, a first adhesive layer on at least part of a surface of the first backing layer, a second backing layer and a second adhesive layer on at least part of a surface of the second backing layer. The second adhesive layer is releasably engaged with the first backing layer and the tape is configured so that the tape can be applied to an article using the first adhesive layer and, after removal from the article, the first backing layer can be removed so that the second backing layer can be applied to the article using the second adhesive layer.

### BACKGROUND OF THE INVENTION

The present invention relates to a multi-use adhesive tape and in particular an adhesive tape that can be used multiple times.

### DESCRIPTION OF THE PRIOR ART

The reference in this specification to any prior publication (or information derived from it), or to any matter which is known, is not, and should not be taken as an acknowledgement or admission or any form of suggestion that the prior publication (or information derived from it) or known matter forms part of the common general knowledge in the field of endeavour to which this specification relates.

Adhesive tapes are extensively in the packing industry to allow boxes or packages to be sealed for shipping. Such packing tapes are typically pressure sensitive tapes that use an acrylic adhesive on a two to three inch wide polypropylene or polyester backing. One problem with tapes of this form is that they are single use only. This can be particularly problematic in the context of packing boxes or similar, as this prevents the box being opened and resealed if the user doesn't have access to further packing tape.

Whilst attempts have been made to make tapes reusable by allowing the adhesive to re-adhere to a surface, such adhesives typically suffer from poor performance, which can lead to packages inadvertently opening, which is undesirable.

U.S. Pat. No. 3,616,114 describes a reusable, composite, adhesive sealing tapes for releasably interconnecting container parts and the like, such as corrugated boxes, paper bags, etc. The tapes, cut to a suitable length and width, include at least two tape portions or laminations, namely a main tape portion and a partly coplanar reinforcing tape portion; optionally, an auxiliary tape portion may also be provided. The inner end of the reinforcing portion is firmly attached to the midportion of the main portion. The latter has a first area adapted to be attached to one side of a first container part, while a second area thereof, including its free end, is adapted to be attached to a second container part which should be releasably interconnected with said first container part; the reinforcing portion is at least partly attachable to the opposite side of the first container part. A turned-up section formed from the inner end of the reinforcing portion may constitute a hinge for said first area of the main portion when it is attached to the respective container part.

This attempts to mitigate the issue with resealing tapes, by providing an auxiliary adhesive tape portion that is engaged with the box, and with a main potion of the tape that releasably engages the auxiliary tape. However, when not used, this leaves the auxiliary tape exposed, and in any event does not address the degradation of adhesion over multiple uses.

### SUMMARY OF THE PRESENT INVENTION

In one broad form, an aspect of the present invention seeks to provide a multi-use adhesive tape including: a first backing layer; a first adhesive layer on at least part of a surface of the first backing layer; a second backing layer; and, a second adhesive layer on at least part of a surface of the second backing layer, wherein the second adhesive layer is releasably engaged with the first backing layer and wherein the tape is configured so that; the tape can be applied to an article using the first adhesive layer; and, after removal from the article, the first backing layer can be removed so that the second backing layer can be applied to the article using the second adhesive layer.

In one embodiment: the first adhesive layer extends over at least part of a first surface of the first backing layer; and, the second adhesive layer is releasably engaged with a second surface of the first backing layer.

In one embodiment the second adhesive layer extends over part of at least one of the first and second backing layers to thereby facilitate separation of the second adhesive layer from the first backing layer.

In one embodiment: the first adhesive layer extends over a first part of a first surface of the first backing layer; and, the second adhesive layer is releasably engaged with a second part of the first surface of the first backing layer.

In one embodiment the tape includes a release layer between the second adhesive layer and the first backing layer.

In one embodiment the tape includes: a first tape portion including: the first backing layer; and, the first adhesive layer on at least part of a surface of the first backing layer; and, a second tape portion including: the second backing layer; and, the second adhesive layer, wherein the second adhesive layer is releasably engaged with the first backing layer so that the first and second tape portions can be separated and wherein the tape is configured so that after removal from the article, the first and second tape portions can be separated so that the second tape portion can be applied to the article using the second adhesive layer.

In one broad form, an aspect of the present invention seeks to provide a multi-use adhesive tape including: a backing layer; an adhesive layer on at least part of a surface of the backing layer; and, a mask layer covering at least part of the adhesive layer so that the adhesive layer includes exposed portions and masked portions, wherein the tape is configured so that: the tape can be applied to an article using exposed portions of the adhesive layer; and, after removal from the article, the mask layer is removed so that the tape can be re-applied to the article using the masked portions of the adhesive layer.

In one embodiment the mask layer includes a lattice of openings that define the exposed portions of the adhesive layer.

In one embodiment the mask layer includes a release layer.

In one embodiment the release layer includes at least one of: silicone release liners; polyester films; polyethylene terephthalate films; polyolefin films; and, polyethylene films.

In one embodiment the backing layer includes at least one of: woven fabric; non-woven fabric; paper; plastic; metal; foil; polypropylene; polyester; polyvinyl chloride; ethylene-propylene-diene monomer rubber; polyurethanes; polymethyl methacrylate; engineering thermoplastics; polyphenylene oxide; polyetheretherketone; polycarbonate; thermoplastic elastomers. cotton; nylon; polyamide; rayon; glass; carbon; ceramics; and, air-laid webs of natural or synthetic fibers.

In one embodiment the adhesive layers include at least one of: pressure sensitive adhesive; heat activated adhesive; and, water activated adhesive.

In one embodiment the adhesive layers include at least one of: (meth)acrylate copolymers; rubber/resins; epoxies; urethanes; poly(meth)acrylate; polyvinyl ether; diene rubber; natural rubber; polyisoprene; polybutadiene; polyisobutylene; polychloroprene; butyl rubber; butadiene-acrylonitrile polymer; thermoplastic elastomer; block copolymers; styrene-isoprene and styrene-isoprene-styrene (SIS) block copolymers; ethylene-propylene-diene polymers; styrene-butadiene polymers; poly-alpha-olefin; amorphous polyolefin; silicone; ethylene-containing copolymers; ethylene vinyl acetate; ethylacrylate; ethyl methacrylate; polyurethane; polyamide; epoxy; polyvinylpyrrolidone and vinylpyrrolidone copolymers; and, polyesters.

In one broad form, an aspect of the present invention seeks to provide a method of manufacturing a multi-use adhesive tape including: manufacturing a first tape portion including: a first backing layer; and, a first adhesive layer on at least part of a surface of the first backing layer; manufacturing a first tape portion including: a second backing layer; and, a second adhesive layer on at least part of a surface of the second backing layer; and, winding a roll using the first and second tape portions so that the second adhesive layer is releasably engaged with the first backing layer.

It will be appreciated that the broad forms of the invention and their respective features can be used in conjunction and/or independently, and reference to separate broad forms is not intended to be limiting. Furthermore, it will be appreciated that features of the method can be performed using the system or apparatus and that features of the system or apparatus can be implemented using the method.

### BRIEF DESCRIPTION OF THE DRAWINGS

Various examples and embodiments of the present invention will now be described with reference to the accompanying drawings, in which:—

FIG. 1A is a schematic perspective view of an example of a multi-use adhesive tape;

FIG. 1B is a schematic end view of the multi-use adhesive tape of FIG. 1A;

FIG. 1C is a schematic end view of the multi-use adhesive tape of FIG. 1A during a first use;

FIG. 1D is a schematic end view of the multi-use adhesive tape of FIG. 1A during a second use;

FIG. 2A is a schematic perspective view of an alternative example of a multi-use adhesive tape;

FIG. 2B is a schematic end view of the multi-use adhesive tape of FIG. 2A;

FIG. 2C is a schematic end view of the multi-use adhesive tape of FIG. 2A during a first use;

FIG. 2D is a schematic end view of the multi-use adhesive tape of FIG. 2A during a second use;

FIG. 3A is a schematic diagram of an example of a process for manufacturing a roll of the multi-use adhesive tape of FIG. 1A;

FIG. 3B is a schematic cross sectional view of a roll of the multi-use adhesive tape of FIG. 1A; and,

FIG. 4 is a schematic perspective view of an alternative example of a multi-use adhesive tape.

### DETAILED DESCRIPTION OF THE PREFERRED EMBODIMENTS

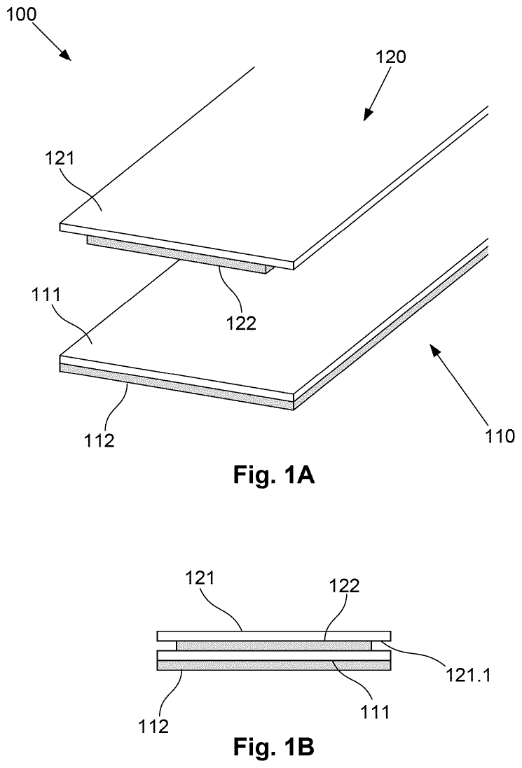

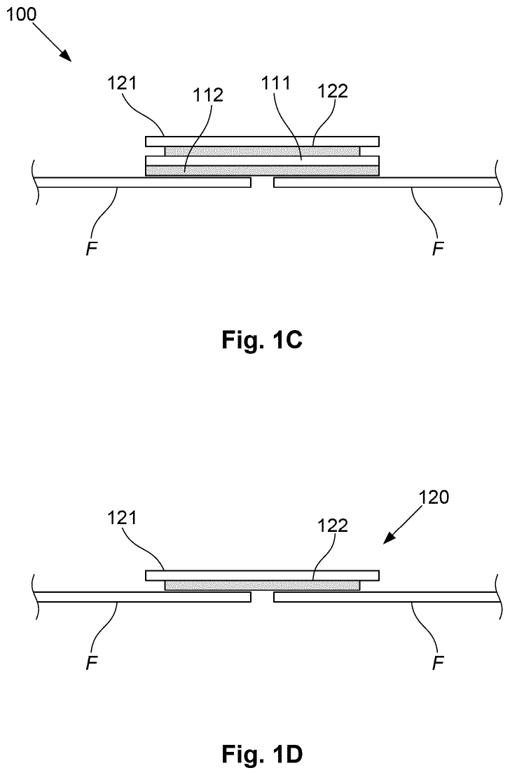

An example of a multi-use adhesive tape will now be described with reference to FIGS. 1A to 1D.

In this example, the multi-use adhesive tape 100 includes a first backing layer 111 having a first adhesive layer 112 on at least part of a surface of the first backing layer 111 and a second backing layer 121 having a second adhesive layer 122 on at least part of a surface of the second backing layer. As will be described in more detail below, the first backing layer 111 and first adhesive layer 112 can form a first tape portion 110, whilst the second backing layer 121 and second adhesive layer 122 can form a second tape portion 120, although this is not essential.

The second adhesive layer 122 is releasably engaged with the first backing layer 111. In this example, this is achieved by having the first adhesive layer 112 extend over at least part of a first surface of the first backing layer 111, with the second adhesive layer 122 being releasably engaged with a second surface of the first backing layer 111, although other arrangements are envisaged as described below. Thus, in this example, the second tape portion 120 is effectively mounted to a rear of the first tape portion 110.

In this arrangement, the tape 100 can be applied to an article by applying the first adhesive layer 112 to the article. In effect, in this scenario, the combination of the first and second backing layers 111, 121 and the first and second adhesive layers 112, 122 acts as a single piece of tape. Thus, this could be used, for example, to close a box, by positioning the tape so that it spans across flaps of the box, either crosswise spanning a gap between the flaps, or lengthwise along the gap, with the tape engaging both flaps, thereby closing the box. An example of this is shown in FIG. 1C, with the tape 100 applied to box flaps F.

In the event that the tape is removed, for example to provide access to contents of the box, the entire tape can be removed, with the first backing layer and second adhesive layer then being separated, so that the second backing layer 121 can be applied to the article using the second adhesive layer 122, as shown in FIG. 1D.

In other words, the first and second tape portions 110, 120 can initially be collectively attached to an article, for example to secure a box by closing the box flaps. In the event access is needed to the box, the first and second tape portions 110, 120 can be removed from the box, which will render the first tape portion inoperable. At this point, the first and second tape portions 110, 120 can be separated so that the second tape portion 120 alone can be applied to the article using the second adhesive layer 122, thereby reclosing the box.

In this arrangement, the second adhesive layer is protected during the first use, ensuring the adhesive properties of the layer are not compromised, in turn allowing reliable second use of the tape. Despite this, the tape can be applied to an article for the first use and then subsequently used for the second use without requiring additional tape. This is particularly convenient as it allows packages, such as boxes to be sealed, and then more easily reused, without requiring access to further adhesive tape.

Whilst reference has been made to closing a box in the above example, it will be appreciated that this is just one example of the use of the tape, and that the tape can be used in a similar manner in any situation where multiple use tape is required.

In the above described example, the second adhesive layer 122 only extends over part of the first and second backing layers 111, 121, so that a flap 121.1 is provided along an edge of the second backing layer 121, to thereby facilitate separation of the second adhesive layer 122 from the first backing layer 111. It will be noted that the flap does not need to extend along entire edge of the tape, and instead could be formed along part of the edge. Similarly, a flap is not required on both edges of the tape, and may be provided on a single edge only.

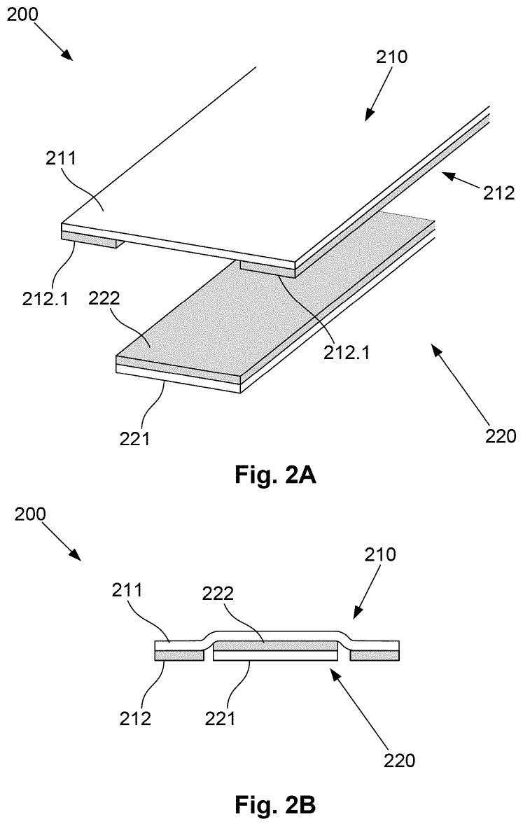

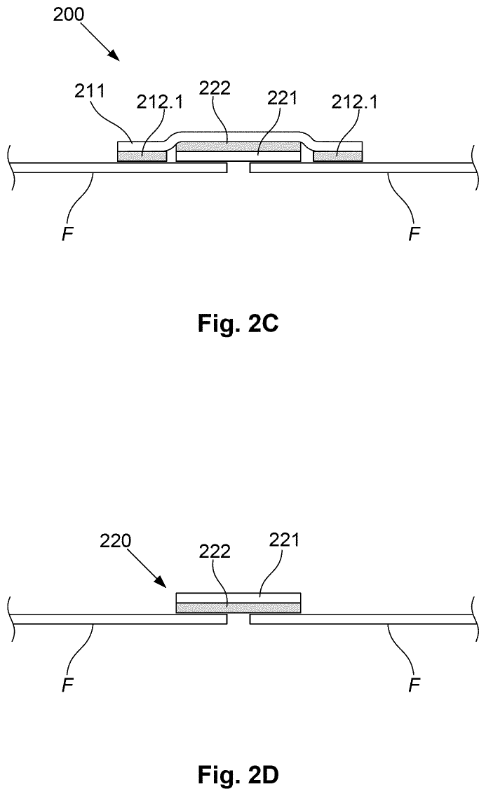

In another example, instead of mounting the second tape portion to the rear of the first tape portion, the second tape portion can be mounted on a front of the first tape portion, and an example of this will now be described with reference to FIGS. 2A and 2B.

In this example, the multi-use adhesive tape 200 includes a first tape portion 210 having a first adhesive layer 212 that extends over a first part of a first surface of the first backing layer 211. In this example, the adhesive layer 212 is provided in strips 212.1 along outer edges of a front of the first back layer 211, although it will be appreciated that other arrangements could be used. The second tape portion 220 again includes a second adhesive layer 222 on a second backing layer 221, with the second adhesive layer releasably engaged with a second part of the first surface of the first backing layer 211. Thus, in this example, the second tape portion 220 is narrower than the first tape portion 210, allowing the second tape portion 220 to be accommodated between the first adhesive layer strips 212.1, as shown in FIG. 2B.

In this arrangement, the tape 200 can be applied to an article by applying the first adhesive layer 212, and in particular the strips 212.1 to the article, as shown for example in FIG. 2C, where each strip 212.1 engages a respective flap F of a box so that the tape spans across the gap between the flaps, thereby closing the box. In the event that the tape is removed, for example to provide access to contents of the box, the entire tape can be removed, with the first backing layer 211 and second adhesive layer 222 then being separated, so that the second backing layer 221 can be applied to the article using the second adhesive layer 222, as shown in FIG. 2D.

A number of further features will now be described.

In one example, the tape includes a release layer between the second adhesive layer and the first backing layer. The release layer can be used to help the second adhesive layer disengage from the first backing layer, ensuring the adhesive properties of the second adhesive layer are unaffected when the second adhesive layer is subsequently attached to an article.

The release layer can include silicone release liners, polyester films, polyethylene terephthalate films, polyolefin films or polyethylene films. Specific examples of suitable release liners include, but are not limited to, release liners sold under the trade designation AKROSIL™ available from Akrosil Europe (Huerlen, Netherlands) and International Paper (Menasha, Wis.); and release liners available from Daubert Coated Products, Inc. (Dixon, Ill.). In some embodiments, the release liner comprises AKROSIL™ Paper Liner ZG-3223 (Akrosil Europe, Huerlen, Netherlands) or AKROSIL™ Paper Liner SBL 60 SC SILOX F1U/F4B (International Paper, Menasha, Wis.).

The backing layer can include any one or more of woven fabric, non-woven fabric, paper, plastic, metal, foil, polyester, polyvinyl chloride, ethylene-propylene-diene monomer rubber, polyurethanes, polymethyl methacrylate, engineering thermoplastics, polyphenylene oxide, polyetheretherketone, polycarbonate, thermoplastic elastomers, cotton, nylon, polyamide, rayon, glass, carbon, ceramics, air-laid webs of natural or synthetic fibres, or the like.

The adhesive layer can include a pressure sensitive adhesive, heat activated adhesive or water activated adhesive. Specifically, this can include (meth)acrylate copolymers, rubber/resins, epoxies, urethanes, poly(meth)acrylate, polyvinyl ether, diene rubber, natural rubber, polyisoprene, polybutadiene, polyisobutylene, polychloroprene, butyl rubber, butadiene-acrylonitrile polymer, thermoplastic elastomer, block copolymers, styrene-isoprene and styrene-isoprene-styrene (SIS) block copolymers, ethylene-propylene-diene polymers, styrene-butadiene polymers, poly-alpha-olefin, amorphous polyolefin, silicone, ethylene-containing copolymers, ethylene vinyl acetate, ethylacrylate, ethyl methacrylate, polyurethane, polyamide, epoxy, polyvinylpyrrolidone and vinylpyrrolidone copolymers, polyesters, or the like.

As mentioned above, in one example, the tape includes a first tape portion including the first backing layer and the first adhesive layer, and a second tape portion including the second backing layer and the second adhesive layer. In this instance, the first and second tape portions effectively act as separate tapes that are initially attached, allowing these to be separated so that after the tape has been removed from an article, the first and second tape portions can be separated so that the second tape portion can be applied to the article using the second adhesive layer.

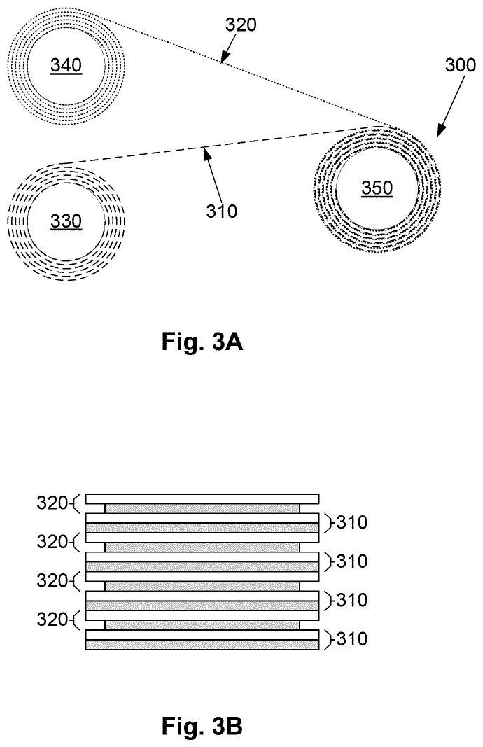

Whilst not essential, the use of respective tape portions in this manner can facilitate manufacture of the tapes, and an example of this will now be described with reference to FIGS. 3A and 3B.

In this example, the first and second tape portions 310, 320 are manufactured separately, using existing manufacturing techniques, to thereby form first and second logs 330, 340 of the first and second tape portions. These can then be wound onto a common log 350, to form the tape 300. Typically this would involve creating a log that is one to three metres wide, and then splitting this using a tape converter, which convert master rolls of tape to usable sizes and forms for customers.

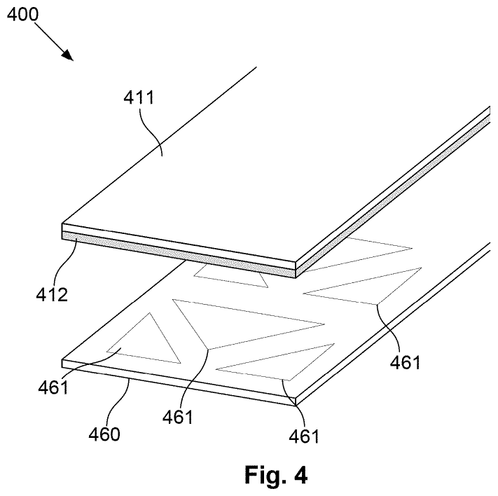

Another example multi-use adhesive tape will now be described with reference to FIG. 4.

In this example, the tape 400 includes a backing layer 411 and an adhesive layer 412 on at least part of a surface of the backing layer 411. The tape further includes a mask layer 460 covering at least part of the adhesive layer so that the adhesive layer includes exposed portions and masked portions. In one example, this is achieved by including a number of openings 461 in the mask layer, which account for approximately half of the surface area of the layer, meaning approximately 50% of the adhesive layer is exposed, whilst the rest is masked, although it will be appreciated other masking arrangements could be used.

In any event, in this example, the tape can be applied to an article a first time using exposed portions of the adhesive layer 412 and then after removal from the article, the mask layer 460 is removed so that the tape can be re-applied to the article using the masked portions of the adhesive layer 412.

Typically the mask layer includes a release layer, allowing it to be removed from the adhesive layer without degrading the adhesive.

Accordingly, the above described arrangements provide a tape that can be used twice by providing different adhesive regions for each of the two different uses. It will be appreciated however that the techniques could be expanded more broadly to any number of uses. For example, in the arrangement of FIG. 1A, multiple tape portions could be provided in a stack, to accommodate multiple uses. Similarly, for the arrangement of FIG. 4, multiple mask layers could be used to allow different regions of the adhesive layer to be selectively exposed.

Throughout this specification and claims which follow, unless the context requires otherwise, the word “comprise”, and variations such as “comprises” or “comprising”, will be understood to imply the inclusion of a stated integer or group of integers or steps but not the exclusion of any other integer or group of integers. As used herein and unless otherwise stated, the term “approximately” means±20%.

Persons skilled in the art will appreciate that numerous variations and modifications will become apparent. All such variations and modifications which become apparent to persons skilled in the art, should be considered to fall within the spirit and scope that the invention broadly appearing before described.

1) A multi-use adhesive tape including:
a) a first backing layer;
b) a first adhesive layer on at least part of a surface of the first backing layer;
c) a second backing layer; and,
d) a second adhesive layer on at least part of a surface of the second backing layer, wherein the second adhesive layer is releasably engaged with the first backing layer and wherein the tape is configured so that;
i) the tape can be applied to an article using the first adhesive layer; and,
ii) after removal from the article, the first backing layer can be removed so that the second backing layer can be applied to the article using the second adhesive layer.

2) A multi-use adhesive tape according to claim 1, wherein:
a) the first adhesive layer extends over at least part of a first surface of the first backing layer; and,
b) the second adhesive layer is releasably engaged with a second surface of the first backing layer.

3) A multi-use adhesive tape according to claim 2, wherein the second adhesive layer extends over part of at least one of the first and second backing layers to thereby facilitate separation of the second adhesive layer from the first backing layer.

4) A multi-use adhesive tape according to claim 1, wherein:
a) the first adhesive layer extends over a first part of a first surface of the first backing layer; and,
b) the second adhesive layer is releasably engaged with a second part of the first surface of the first backing layer.

5) A multi-use adhesive tape according to claim 1, wherein the tape includes a release layer between the second adhesive layer and the first backing layer.

6) A multi-use adhesive tape according to claims 1, wherein the tape includes:
a) a first tape portion including:
i) the first backing layer; and,
ii) the first adhesive layer on at least part of a surface of the first backing layer; and,
b) a second tape portion including:
i) the second backing layer; and,
ii) the second adhesive layer, wherein the second adhesive layer is releasably engaged with the first backing layer so that the first and second tape portions can be separated and wherein the tape is configured so that after removal from the article, the first and second tape portions can be separated so that the second tape portion can be applied to the article using the second adhesive layer.

7) A multi-use adhesive tape including:
a) a backing layer;
b) an adhesive layer on at least part of a surface of the backing layer; and,
c) a mask layer covering at least part of the adhesive layer so that the adhesive layer includes exposed portions and masked portions, wherein the tape is configured so that:
i) the tape can be applied to an article using exposed portions of the adhesive layer; and,
ii) after removal from the article, the mask layer is removed so that the tape can be re-applied to the article using the masked portions of the adhesive layer.

8) A multi-use adhesive tape according to claim 7, wherein the mask layer includes a lattice of openings that define the exposed portions of the adhesive layer.

9) A multi-use adhesive tape according to claim 7 wherein the mask layer includes a release layer.

10) A multi-use adhesive tape according to claim 1, wherein the release layer includes at least one of:
a) silicone release liners;
b) polyester films;
c) polyethylene terephthalate films;
d) polyolefin films; and,
e) polyethylene films.

11) A multi-use adhesive tape according to claims 1, wherein the backing layer includes at least one of:
a) woven fabric;
b) non-woven fabric;
c) paper;
d) plastic;
e) metal;
f) foil;
g) polypropylene;
h) polyester;
i) polyvinyl chloride;
j) ethylene-propylene-diene monomer rubber;
k) polyurethanes;
l) polymethyl methacrylate;
m) engineering thermoplastics;
n) polyphenylene oxide;
o) polyetheretherketone;
p) polycarbonate;
q) thermoplastic elastomers.
r) cotton;
s) nylon;
t) polyamide;
u) rayon;
v) glass;
w) carbon;
x) ceramics; and,
y) air-laid webs of natural or synthetic fibers.

12) A multi-use adhesive tape according to claim 1, wherein the adhesive layers include at least one of:
a) pressure sensitive adhesive;
b) heat activated adhesive; and, c) water activated adhesive.

13) A multi-use adhesive tape according to claim 1, wherein the adhesive layers include at least one of:
a) (meth)acrylate copolymers;
b) rubber/resins;
c) epoxies;
d) urethanes;
e) poly(meth)acrylate;
f) polyvinyl ether;
g) diene rubber;
h) natural rubber;
i) polyisoprene;
j) polybutadiene;
k) polyisobutylene;
l) polychloroprene;
m) butyl rubber;
n) butadiene-acrylonitrile polymer;
o) thermoplastic elastomer;
p) block copolymers;
q) styrene-isoprene and styrene-isoprene-styrene (SIS) block copolymers;
r) ethylene-propylene-diene polymers;
s) styrene-butadiene polymers;
t) poly-alpha-olefin;
u) amorphous polyolefin;
v) silicone;
w) ethylene-containing copolymers;
x) ethylene vinyl acetate;
y) ethylacrylate;
z) ethyl methacrylate;
aa) polyurethane;
bb) polyamide;
cc) epoxy;
dd) polyvinylpyrrolidone and vinylpyrrolidone copolymers; and,
ee) polyesters.

14) A method of manufacturing a multi-use adhesive tape including:
a) manufacturing a first tape portion including:
i) a first backing layer; and,
ii) a first adhesive layer on at least part of a surface of the first backing layer;
b) manufacturing a first tape portion including:
i) a second backing layer; and,
ii) a second adhesive layer on at least part of a surface of the second backing layer; and,
c) winding a roll using the first and second tape portions so that the second adhesive layer is releasably engaged with the first backing layer.

15) A multi-use adhesive tape according to claim 9, wherein the release layer includes at least one of:
a) silicone release liners;
b) polyester films;
c) polyethylene terephthalate films;
d) polyolefin films; hand
e) polyethylene films.
